(19) United States
(12) Patent Application Publication
(10) Pub. No.: US 2006/0082144 A1
(43) Pub. Date: Apr. 20, 2006

(54) Dustroof cap for quick connector and quick conector

(75) Inventor: Hiroyuki Okada, Koga-Shi (JP)

Correspondence Address: LADAS & PARRY, 26 WEST 61ST STREET, NEW YORK, NY, 10023, US

(73) Assignee: Sanoh Kogyo Kabushiki Kaisha, Ibaraki-Ken (JP)

(21) Appl. No.: 10/543,355

(22) PCT Filed: Feb. 17, 2004
(86) PCT No.: PCT/JP04/01730

§ 371 Date: Jul. 26, 2005

(30) Foreign Application Priority Data
Feb. 20, 2003 (JP) 2003-042582

(51) Int. Cl. F16L 37/00

(52) U.S. Cl. 285/305

(57) ABSTRACT

A dust plug 16 combined with a quick connector 10 having a connector body 15 and a retainer 14 prevents the retainer 14 from moving to a locking position in the connector body 15. The cylindrical dust plug 16 has an O ring protecting part 16a and a retainer stopping part 16b formed integrally with the O ring protecting part 16a. When the dust plug 16 is combined with the connector body 15, the O ring protecting part 16a fits in O rings held in the connector body 15, and the retainer stopping part 16b prevents the retainer 14 from moving to the locking position in the connector body 15.

### TECHNICAL FIELD

The present invention relates to a quick connector for coupling tubes of an automotive fuel system, an automotive pneumatic system or an automotive hydraulic system. More particularly, the present invention relates to a dust plug for protecting an O ring included in a quick connector from foreign matters, such as dust.

### BACKGROUND ART

Quick connectors are used, for example, for connecting fuel tubes of automotive fuel systems. The quick connector is capable of simply and quickly connecting tubes without using any fastening means, such as bolts. The quick connector has a connector body to be attached to one of two tubes, and a retainer to be pressed in the connector body after inserting the other tube in the connector body to retain the tube in the coupling body. A representative quick connector is disclosed in U.S. Pat. No. 5,542,716.

An annular ridge is formed on the outer circumference of an end part of a tube to be inserted in the connector body. The retainer is pressed radially in the connector body. The retainer is engaged with the annular ridge to restrain the tube from coming off the connector body. The quick connector of the type is designed such that the retainer does not exercise its locking function unless the retainer is completely pressed in the connector body.

In some cases, a dust plug is put on the conventional quick connector before shipping the quick connector to prevent the entrance of foreign matters, such as dust, into the quick connector. Thus foreign matters are prevented from entering the quick connector by the dust plug because an O ring held in the quick connector will be impaired if foreign matters adhere to the O ring.

Usually, a temporary quick connector assembly formed by combining the connector body, the retainer and, when necessary, the dust plug is delivered to the user. In the temporary quick connector assembly, the retainer is not fully pressed in the connector body. When the quick connector is used, the retainer is simply pressed in the connector body after fully inserting a tube in the connector body.

In the quick connector provided with the dust plug, the retainer can be locked to the connector body even if the dust plug is not removed. Therefore, it often occurs that the retainer is locked to the connector body by mistake before the quick connector is used.

### DISCLOSURE OF THE INVENTION

Accordingly, it is an object of the present invention to solve the foregoing problems in the prior art, and to provide a quick connector including a connector body and a retainer, and to provide a dust plug for the quick connector, capable of inhibiting locking the retainer to the connector body unless the same is removed from the quick connector.

The present invention provides a dust plug for a quick connector including a connector body and a retainer incapable of retaining in the connector body a tube provided with an annular ridge and incompletely inserted in the connector body, having: a dust plug body for protecting 0 rings held in the connector body from foreign matters; and a retainer stopping part formed integrally with the dust plug body and capable of interfering with a part of the retainer; wherein the O ring protecting part is fitted in the O rings and the retainer stopping part holds the retainer at a position where the retainer is unable to retain the tube, when the dust plug body is inserted in the connector body.

The dust plug according to the present invention may be a cylindrical member integrally having a first cylindrical part of a small diameter as the O ring protecting part, and a second cylindrical part of a large diameter as the retainer stopping part.

The dust plug may have a cylindrical part as the O ring protecting part, and a stopping projection capable of engaging with a part of a sliding retainer outside the connector body.

A quick connector according to the present invention includes: a connector body, and a retainer; wherein the retainer is unable to retain a tube provided with an annular ridge and incompletely inserted in the connector body in the connector body, the connector body can receive the dust plug of the present invention therein, and the retainer can be combined with the connector body so as to be restrained from movement into the connector body by the dust plug.

### BRIEF DESCRIPTION OF THE DRAWINGS

FIG. 1A is an exploded perspective view of a quick connector, and a dust plug in a first embodiment according to the present invention to be used in combination with the quick connector;

FIG. 1B is a perspective view of an end part of a tube to be connected to another tube by the quick connector;

FIG. 2 is a longitudinal sectional view of a temporary quick connector assembly formed by combining the quick connector including a connector body and the retainer, and the dust plug;

FIG. 3 is a cross-sectional view taken on the line Ill-III in FIG. 2;

FIG. 4 is a longitudinal sectional view of the quick connector and the tube retained in the quick connector; and

FIG. 5 is a longitudinal sectional view of a temporary quick connector assembly formed by combining a dust plug in a second embodiment according to the present invention with a quick connector.

### BEST MODE FOR CARRYING OUT THE INVENTION

Dust plugs in preferred embodiments according to the present invention and a temporary quick connector assembly will be described with reference to the accompanying drawings.

### First Embodiment

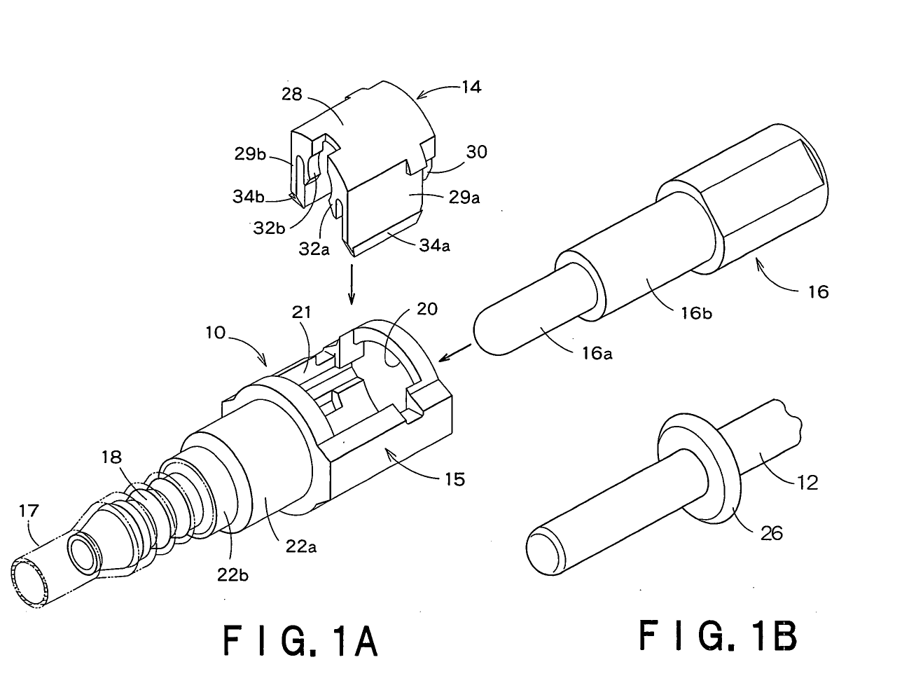

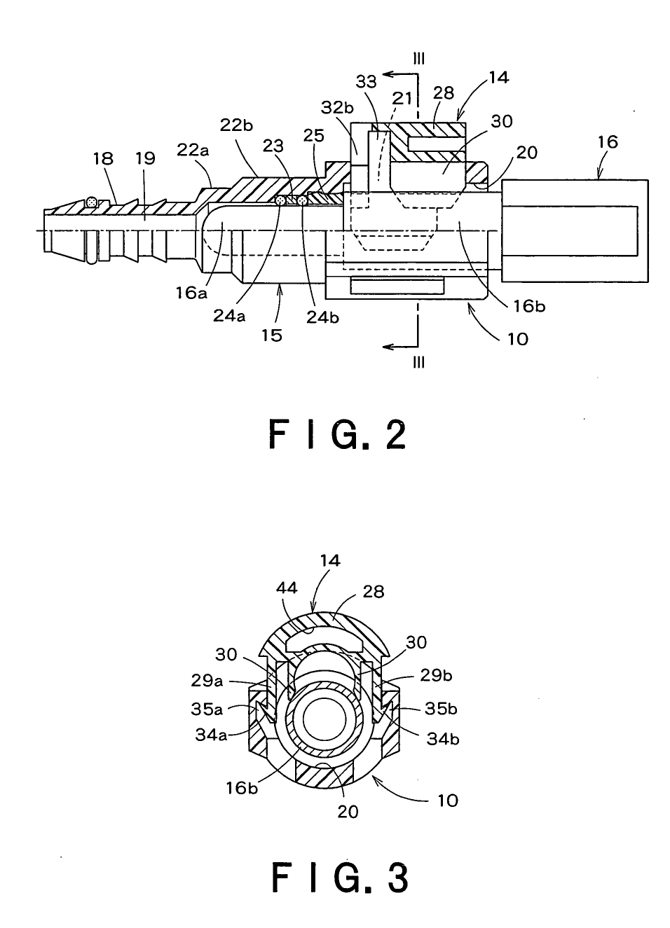

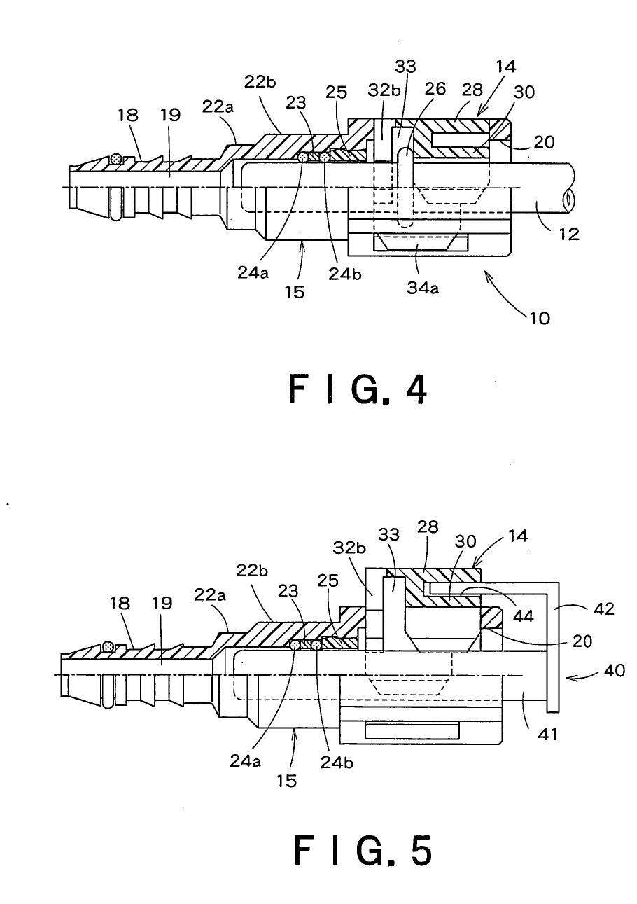

FIG. 1A is an exploded perspective view of a quick connector 10 to be used in combination with a dust plug 16 in a first embodiment according to the present invention. Shown in FIG. 1A are the quick connector 10 including a retainer 14 and a connector body 15, a tube 12 to be inserted in and fixedly retained the quick connector 10, the retainer 14 for retaining the tube 12 in the quick connector 10 and the cap 16. FIG. 2 is a longitudinal sectional view of a temporary quick connector assembly formed by combining the connector body 15, the retainer 14 and the dust plug 16, FIG. 3 is a cross-sectional view taken on the line III-III in FIG. 2, and FIG. 4 is a longitudinal sectional view of the quick connector 10 and the tube 12 retained in the quick connector 10 by the retainer 14.

This embodiment is the application of the present invention to the quick connector 10 designed to retain the tube 12 inserted in the connector body 15 by pressing the sliding retainer 14 through an opening formed in the connector body 15 in a radial direction into the connector body 15.

Referring to FIG. 1, a serrated tube connector 18 is formed integrally with the connector body 15 of the quick connector 10. The serrated tube connector 18 is forced into a resin tube 17. A stepped passage 19 is formed axially through the connector body 15 as shown in FIG. 2. An entrance opening 20 through which the tube 12 is inserted in the connector body 15 is formed at one end, opposite the other end provided with the serrated tube connector 18, of the connector body 15. An opening 21, through which the retainer 14 is pressed into the connector body 15 in a direction perpendicular to the axis of the connector body 15 is formed in a side wall of the connector body 15.

The connector body 15 has a first cylindrical part 22a, a second cylindrical part 22b continuous with the first cylindrical part 22a, and the tube connector 18 continuous with the second cylindrical part 22b. As shown in FIG. 2, O rings 24a and 24b are fitted in the first cylindrical part 22a. The O rings 24a and 24b are spaced apart by a spacer 23. The O rings 24a and 24b are held in place by a top hat 25 Referring to FIG. 1, the tube 12 is a metal tube provided with an annular ridge 26 in an end part thereof at a predetermined distance from the free end thereof. The retainer 14 pressed through the opening 21 of the connector body 15 engages with the annular ridge 26 to restrain the tube 12 from separating from the connector body 15.

The retainer 14 is a plastic or metal member having a body 28 provided with parallel locking legs 29a and 29b. As shown in FIG. 3, a substantially U-shaped rib 30 is formed integrally with the locking legs 29a and 29b of the retainer 14. The U-shaped rib 30 has a curved inner surface of a curvature substantially equal to that of the outer surface of the tube 12. The tube 12 inserted in the connector body 15 fits in the rib 30.

As shown in FIG. 1, the retainer 14 is provided with holding ribs 32a and 32b for holding the top hat 25 at a predetermined distance from an end surface of the U-shaped rib 30.

Referring to FIG. 4, in a sate where the tube 12 has been fully inserted in the connector body 15 and gaps between the connector body 15 and the tube 12 have been effectively sealed by the O rings 24a and 24b, the annular ridge 26 is placed in a space 33 between the end surface of the U-shaped rib 30 and the end surfaces of the holding ribs 32a and 32b. The retainer 14 is pressed into the connector body 15 in this state to lock the tube 12 to the connector body 15.

When the retainer 14 is thus pressed into the connector body 15, locking hooks 34a and 34b formed at the lower ends of the locking legs 29a and 29b of the retainer 16 engage with the lower edges of side walls of the connector body 15, respectively, to retain the retainer 14 in the connector body 15. When the retainer 14 is thus locked in place, the annular ridge 26 of the tube 12 is in contact with the end edge of the rib 30 of the retainer 14 and the tube 12 is restrained from axially backward movement. Thus the tube 12 and the connector body 15 of the quick connector 10 are connected firmly together by the retainer 14.

In a state where the tube 12 is not inserted sufficiently deep into the connector body 15, the annular ridge 26 of the tube 12 interferes with the rib 30 of the retainer 14 to obstruct the insertion of the retainer 14 in the connector body 15. Consequently, the tube 12 cannot be locked in place in the connector body 15.

The dust plug 16 is used in combination with the quick connector 10.

Referring to FIG. 1A, the dust plug 16 is formed of a resin and has a shape resembling a stepped cylinder. The dust plug 16 has a cylindrical front part serving as an O ring protecting part 16a, and a cylindrical back part 16b serving as a retainer stopping part 16b. The diameter of the O ring protecting part 16a is smaller than that of the retainer stopping part 16b. The retainer stopping part 16b obstructs the insertion of the retainer 14 in the connector body 15.

Referring to FIG. 2, the diameter of the O ring protecting part 16a is slightly smaller than the respective inside diameters of the first cylindrical part 22a and the second cylindrical part 22b and corresponds to the outside diameter of the tube 12. The O ring protecting part 16a fits close in the O rings 24a and 24b.

Half the diameter of the retainer stopping part 16b of the dust plug 16 is greater than the radius of curvature of the inner curved surface of the rib 30 of the retainer 14 as shown in FIG. 3. The diameter of the retainer stopping part 16b is determined so that the rib 30 is unable to engage close with the retainer stopping part 16b. Preferably, the diameter of the retainer stopping part 16b is approximately equal to the diameter of the annular ridge 26 of the tube 12.

A temporary quick connector assembly is formed by inserting the retainer 14 through the opening 21 half deep in the connector body 15 as shown in FIG. 2 after inserting the duct cap 16 sufficiently deep in the connector body 15 of the quick connector 10. The quick connector 10 is delivered to the user in the temporary quick connector assembly.

Referring to FIGS. 2 and 3, the O rings 24a and 24b held in the connector body 15 are surely protected from foreign matters, such as dust, by the O ring protecting part 16a of the dust plug 16, and the insertion of the retainer 14 in the connector body 15 to the locking position is obstructed by the retainer stopping part 16b in engagement with the rib 30 of the retainer 14. Thus the retainer 14 will not be accidentally inserted in the connector body 15 to the locking position.

Preferably, recesses 35a and 35b capable of receiving the locking hooks 34a and 34b of the locking legs 29a and 29b of the retainer are formed in the inner surfaces of the right and the left side wall, respectively, of the connector body 15 of the quick connector 10 as shown in FIG. 3. Even if the retainer 14 of the temporary quick connector assembly is pulled outward, the locking hooks 34a and 34b engage with the upper edges of the recesses 35a and 35b and hence the retainer 14 is prevented from coming off the connector body 15.

When the quick connector 10 is used practically for connecting tubes, the tube 12 can be firmly connected to the quick connector 10 simply by removing the dust plug 16 from the quick connector 10, inserting the tube 12 in the connector body 15, and pressing the retainer 14 in the connector body 15. Thus the entrance of foreign matters into the interior of the quick connector 10 before connecting the tube 12 to the quick connector 10 can be prevented.

### Second Embodiment

A dust plug 40 in a second embodiment according to the present invention will be described with reference to FIG. 5.

The dust plug 40 has a straight, cylindrical body 41, and an L-shaped retainer stopping arm 42 extending from the back end of the cylindrical body 41.

A temporary quick connector assembly as shown in FIG. 5 is formed by inserting the retainer 14 through the opening 21 half deep in the connector body 15, and fully inserting the dust plug 40 in the connector body 15. In the temporary quick connector assembly, a front end part of the cylindrical body 41 fits in the O rings 24a and 24b to protect the O rings 24a and 24b from foreign matters. When the dust plug 40 is inserted in the connector body 15, an end part of the retainer stopping arm 42 engages in an opening 44 formed in the body 28 of the retainer 14 to restrain the retainer 14 from moving to its locking position. Thus the retainer 14 will not be accidentally moved to the locking position in the connector body 15. The retainer stopping arm 42 may be engaged with a part of the retainer 14 other than the opening 44. For example, the free end of the retainer stopping arm 42 may be engaged with the lower edge of the rib 30 to restrain the retainer 14 from moving into the connector body 15.

Although the present invention has been described as applied to the quick connector that retains the tube in the connector body by the sliding retainer, the dust plug of the present invention is applicable to a quick connector that retains the tube in the connector body by a rotary retainer.

As apparent from the foregoing description, according to the present invention, the dust plug combined with the quick connector prevents the adhesion of foreign matters to the O rings held in the connector body and surely prevents the movement of the retainer to the locking position in the connector body.

1. A dust plug for a quick connector including a connector body and a retainer incapable of retaining in the connector body a tube provided with an annular ridge and incompletely inserted in the connector body, said dust plug having:
a dust plug body for protecting O rings held in the connector body from foreign matters;
a retainer stopping part formed integrally with the dust plug body and capable of interfering with a part of the retainer;
wherein the O ring protecting part is fitted in the O rings and the retainer stopping part holds the retainer at a position where the retainer is unable to retain the tube, when the dust plug body is inserted in the connector body.

2. The dust plug according to claim 1, being a cylindrical member integrally having a first cylindrical part of a small diameter as the O ring protecting part, and a second cylindrical part of a large diameter as the retainer stopping part.

3. The dust plug according to claim 1, having a cylindrical part as the O ring protecting part, and a stopping arm capable of engaging with a part of a sliding retainer outside the connector body.

4. A quick connector comprising:
a connector body; and
a retainer;
wherein the retainer is unable to retain a tube provided with an annular ridge and incompletely inserted in the connector body in the connector body, the connector body can receive the dust plug according to claim 1, and the retainer can be combined with the connector body so as to be restrained from movement into the connector body by the dust plug.

5. A quick connector comprising:
a connector body; and
a retainer;
wherein the retainer is unable to retain a tube provided with an annular ridge and incompletely inserted in the connector body in the connector body, the connector body can receive the dust plug according to claim 2, and the retainer can be combined with the connector body so as to be restrained from movement into the connector body by the dust plug.

6. A quick connector comprising:
a connector body; and
a retainer;
wherein the retainer is unable to retain a tube provided with an annular ridge and incompletely inserted in the connector body in the connector body, the connector body can receive the dust plug according to claim 3, and the retainer can be combined with the connector body so as to be restrained from movement into the connector body by the dust plug.
